(19) United States
(12) Patent Application Publication
(10) Pub. No.: US 2006/0119873 A1
(43) Pub. Date: Jun. 8, 2006

(54) Image forming apparatus and control method thereof

(75) Inventors: Jae-kyoo Kang, Yong-si (KR); Jae-pyoung Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/288,079

(22) Filed: Nov. 29, 2005

(30) Foreign Application Priority Data
Dec. 3, 2004 (KR) 2004-0101431

(51) Int. Cl. G06F 3/12

(52) U.S. Cl. 358/1.13

(57) ABSTRACT

An image forming method and apparatus provided with a plurality of output trays, the image forming apparatus including an image forming unit for printing an image on a paper; a tray selecting unit for outputting the printed paper to one of the plurality of output trays; and a control unit for dividing print data into at least two or more page groups in page number order, wherein the control unit controls the image forming unit so that the print data belonging to each page group is printed by the page and in turn, and controls the tray selecting unit so that the printed paper is transported to the output trays in turn, wherein the number of which is equal to or greater than the number of page groups.

### CROSS-REFERENCE TO RELATED APPLICATION

This application claims the benefit of Korean Patent Application No. 2004-0101431, filed on Dec. 3, 2004, in the Korean Intellectual Property Office, the entire disclosure of which is incorporated herein by reference.

### BACKGROUND OF THE INVENTION

1. Field of the Invention

The present invention relates to an image forming apparatus and a control method thereof. More particularly, the present invention relates to an image forming apparatus provided with a plurality of output trays and outputting printed papers to each output tray in turn and a control method thereof.

2. Description of the Related Art

Recently, there have been a number of apparatuses introduced on the consumer market having multiple functions to achieve a more efficient working environment and increase office automation. For example, there has been proposed a multi function printer (MFP) having at least two functions of a fax machine, a copier, a printer, and a scanner.

Such a multi function printer processes print data generated therein or supplied from an external device, and prints the print data on a sheet of paper as an image. In this MFP printer, the paper is transported to an image forming unit from a paper cabinet or a paper tray to be printed, and then the printed paper is output from the image forming unit to an output tray.

Typically, there are two ways to print on paper. One is an electronic photo-type employed in a laser printer, and the other is an inkjet type of printer. In the electronic photo-type printer, the image is formed on the paper by a developer and then is fixed by a hot-press fusing unit.

However, the conventional image forming apparatus like the multi function printer, a single function printer, or the like have a disadvantage when printing the print data for a plurality of pages. In the case where a next sheet of paper is output before the toner or ink on the paper previously output has dried, the image printed on the paper can be smudged by being contacted by the next sheet of paper or the back of the next sheet of paper can be stained with the toner or ink from the sheet of paper previously output or both.

To solve the above disadvantage, there has been proposed an image forming apparatus provided with a plurality of the output trays and outputting the printed papers to each tray in turn, thereby lengthening the time for drying the toner or ink on the output paper. However, in this image forming apparatus, the plurality of printed papers are outputted to each output tray in turn in page number order, thus a user has to rearrange the output papers in page number order when a printing process is finished.

### SUMMARY OF THE INVENTION

Accordingly, it is an aspect of the present invention to provide an image forming apparatus having a plurality of output trays, which outputs printed pages to each output tray in turn, and arranges the printed papers output to each output tray in numerical or page order and a control method thereof.

The foregoing and/or other aspects of the embodiments of the present invention are also achieved by providing an image forming apparatus provided with a plurality of output trays, the image forming apparatus comprising an image forming unit for printing an image on a paper; a tray selecting unit for outputting the printed paper to one of the plurality of output trays; and a control unit for dividing the print data into at least two or more page groups in page number order, for controlling the image forming unit so that the print data belonging to each page group is printed by the page and in turn, and for controlling the tray selecting unit so that the printed paper is transported to the output trays, the number of which is the same as that of the page groups, in turn.

According to an embodiment of the present invention, the control unit comprises a printer control unit for controlling a printing operation of an image forming unit and a printer driver for converting a format of the print data into the format to be processed by the printer control unit; and the printer driver for dividing the print data into the page groups and converting the format of the print data into the format to be processed by the printer control unit, so that the print data belonging to each page group is printed by the page and in turn.

According to an embodiment of the present invention, the printer driver transmits a print command to the printer control unit by which the papers printed by the image forming unit are transported to each output tray in turn; and the printer control unit controls the tray selecting unit if the print control unit receives the print command from the printer driver, so that the printed paper is output to the output trays in turn.

According to the embodiment of the present invention, the control unit comprises a printer control unit for controlling a printing operation of the image forming unit and a printer driver for converting a format of the print data into the format to be processed by the printer control unit; and the printer control unit for dividing the converted print data provided from the printer driver into the page groups, and controlling the image forming unit so that the converted print data belonging to each page group is printed by the page and in turn.

According to an embodiment of the present invention, the control unit classifies the page groups according to how many times the print data is printed repeatedly when the control unit detects that the print data is printed repeatedly at predetermined times.

According to an embodiment of the present invention, the control unit divides the print data into the page groups, the number of which is the same as that of the plurality of output trays.

According to an embodiment of the present invention, the image forming apparatus further comprises a mode setting unit, which determines whether to set the output to be output by groups; wherein, in the case that the grouping output is selected by the mode setting unit, the control unit controls the image forming unit so that the print data belonging to each page group is printed by the page and in turn, and controls the tray selecting unit so that the printed papers are output to each output tray in turn.

According to an embodiment of the present invention, the plurality of output trays comprise a first output tray facing a printed side of the printed paper and a second output tray facing an opposite side of the printed side of the printed paper; the control unit controls the image forming unit, so that the print data belonging to the page group corresponding to the first output tray is printed by the image forming unit in page number order and the print data belonging to the page group corresponding to the second output tray is printed by the image forming unit in reverse page number order.

The foregoing and/or other aspects of the present invention are also achieved by providing a control method of an image forming apparatus provided with a plurality of output trays, the control method comprising the steps of dividing print data into at least two or more page groups in page number order, wherein the page groups are assigned to a corresponding one of the plurality of output trays; converting the print data so that the print data belonging to each page group by the page and in turn; printing the converted print data on a paper; and transporting the printed papers to each output tray, of which the number is the same as that of the page groups, in turn.

According to an embodiment of the present invention, the dividing of the print data into the at least two page groups comprises: detecting the total page number of the print data; and generating a first printed page number of each page group based on the detected total page number and the number of the page groups.

According to the embodiment of the present invention, the dividing of the print data into at least two or more page groups further comprises: detecting whether the print data is repeatedly printed in predetermined times; and dividing the page groups according to how many times the print data is printed repeatedly when detecting that the print data is printed repeatedly in the predetermined times.

According to the embodiment of the present invention, the step of converting the print data comprises converting the print data so that the print data is printed from the print data corresponding to a first printed page of each page group by the page and in turn for each page group.

According to an embodiment of the present invention, the output trays comprise a first output tray facing a printed side of the printed paper and a second output tray facing the opposite side of the printed side of the printed paper; the converting the print data comprises the step of converting the print data, so that the print data belonging to the page group corresponding to the first output tray is printed in page number order and the print data belonging to the page group corresponding to the second output tray is printed in reverse page number order.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a control block diagram of an image forming apparatus according to an embodiment of the present invention;

FIG. 2 illustrates output trays and a tray selecting unit of FIG. 1 according to an embodiment of the present invention;

FIG. 3 is a detailed control block diagram of the image forming apparatus of FIG. 1 according to an embodiment of the present invention; and

FIG. 4 is a flowchart of an image forming apparatus according to an embodiment of the present invention.

It should be understood that like reference numbers refer to like features, structures and elements.

### DETAILED DESCRIPTION OF EXEMPLARY EMBODIMENTS

Reference will now be made in detail to exemplary embodiments of the present invention, examples of which are illustrated in the accompanying drawings. The exemplary embodiments are described below in order to explain the present invention by referring to the figures.

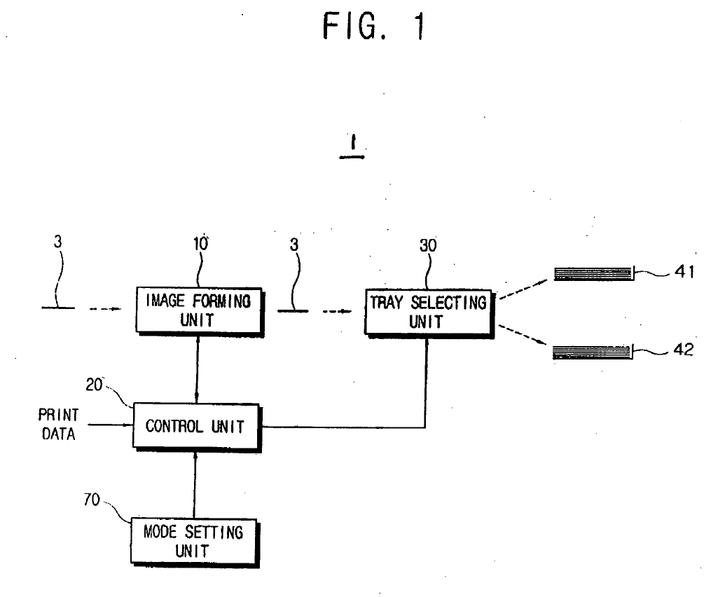

FIG. 1 is a control block diagram of an image forming apparatus 1 according to an embodiment of the present invention. As shown therein, the image forming apparatus 1 comprises a plurality of output trays 41 and 42, a tray selecting unit 30, an image forming unit 10, and a control unit 20.

Herein, the image forming apparatus 1 has two output trays 41 and 42, but the image forming apparatus may have three or more output trays. Hereinafter, the two output trays 41 and 42 are referred to a first output tray 41 and a second output tray 42, respectively.

According to a signal from the control unit 20, the tray selecting unit 30 selects either the first output tray 41 or the second output tray 42 to output a printed paper 3 from the image forming unit 10.

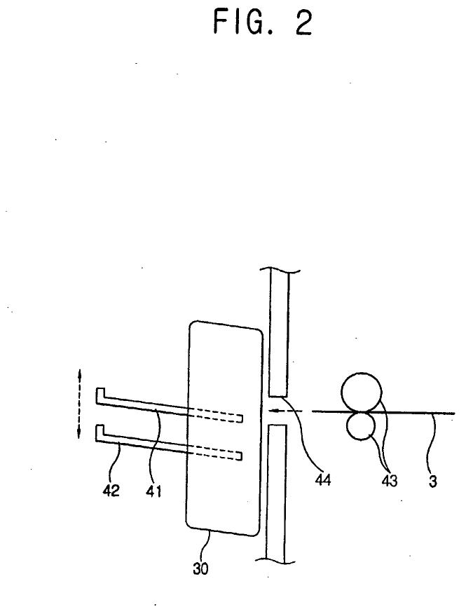

FIG. 2 shows the output trays 41 and 42 and the tray selecting unit 30. As shown therein, the paper 3 printed by the image forming unit 10 is transported to an output opening 44 by an output roller 43. At this moment, the tray selecting unit 30 moves the first output tray 41 and the second output tray 42 upward or downward so that either the first output tray 41 or the second output tray 42 is positioned at the output opening 44. Accordingly, the paper 3 printed by the image forming unit 10 can be transported to either the first output tray 41 or the second output tray 42.

Here, the tray selecting unit 30 may have other configurations so long as it is capable of outputting the paper 3 printed by the image forming unit 10 to either the first output tray 41 or the second output tray 42. For example, The Korean Patent Laid-Open Publication No. 1997-062823, the entire disclosure of which is hereby incorporated by reference, discloses a paper route changing device capable of outputting the printed paper 3 to either the first output tray 41 or the second output tray 42.

The image forming unit 10 prints an image on the paper 3 according to a control of the control unit 20. The image forming unit 10 can print the image on the paper 3 by means of an inkjet method or an electrophotographic method.

In the case that the image forming unit 10 prints the image by means of the electrophotographic method, the image forming unit 10 forms a latent electrostatic image on a photosensitive object such as a photosensitive drum, a photosensitive belt, or the like, develops the latent electrostatic image using development materials having predetermined colors therein, for example, a toner, and then fuses the electrostatic image to the paper 3, thereby forming the desired image.

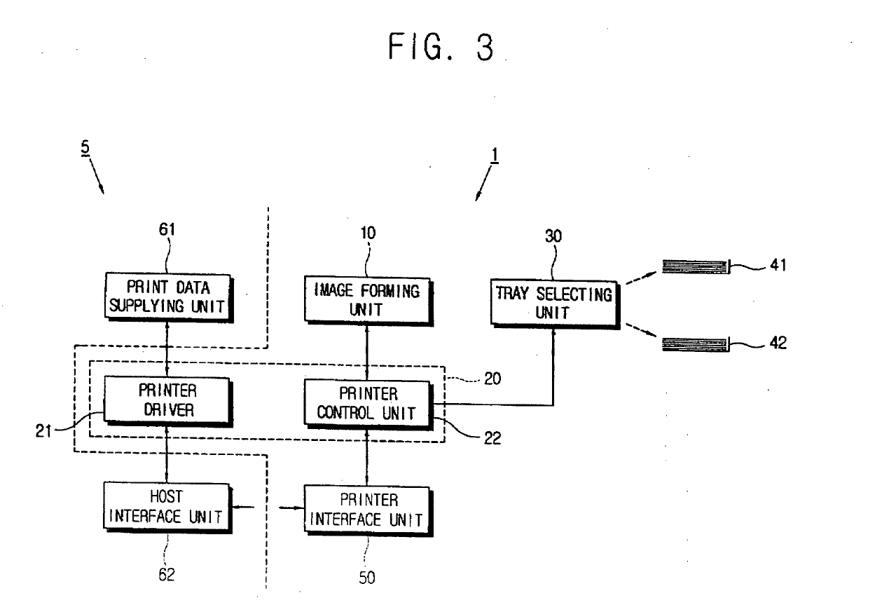

Referring to FIG. 3, the control unit 20 processes the print data provided from a print data supplying unit 61, and controls the image forming unit 10 so that the print data is printed on the paper 3. Also, the control unit 20 controls the tray selecting unit 30 so that the paper 3 output from the image forming unit 10 is transported to either the first output tray 41 or the second output tray 42.

The control unit 20 divides the print data provided from the print data supplying unit 61 into at least two or more page groups. Also, the control unit 20 controls the image forming unit 10 so that the print data belonging to each page group is printed by the page for each group, wherein each page group receives a printed paper 3 page in turn prior to receiving a subsequent page.

In this case, the control unit 20 controls the tray selecting unit 30 so that the paper 3 printed by the image forming unit 10 is transported to the output trays 41 and 42 in turn, preferably the number of output trays is the equal to or greater than the number of page groups. As previously described, because the image forming apparatus 1 introduced herein has at least two output trays 41 and 42, the control unit 20 divides the print data into at least two page groups, respectively.

According to the above configuration, when the image forming apparatus 1 prints the print data of a number of pages to the papers 3, the printed paper 3 is output to either the first output tray 41 or the second output tray 42. Thus, the time interval between the papers 3 being output to a first output tray 41 and subsequently to a second output tray 42 becomes longer, whereby a blurring or smudging of the toner or the ink due to contact between the papers 3 output to each output tray 41 and 42 is remarkably reduced.

Further, the image forming apparatus 1 does not print the print data sequentially in page number order, but divides the print data into a plurality of page groups according to the page number order and prints a printed paper 3 page from each page group in turn, whereby a user just puts together the printed papers 3 outputted to each output tray 41 and 42 to arrange the papers 3 output to each output tray 41 and 42 in page number order.

Hereinafter, the image forming apparatus 1 will be described in more detail by referring to FIG. 3.

The control unit 20 may comprise a printer control unit 22 controlling a printing operation of the image forming unit 10, and a printer driver 21 converting the format of the print data provided from the print data supplying unit 61 into a format which can be processed by the printer control unit 22.

The printer driver 21 may convert the print data into a printer language like print command language (PCL) or post script (PS). Here, the printer driver 21 is installed in a host 5 of a computer or else connected to the image forming apparatus 1 and then is stored therein.

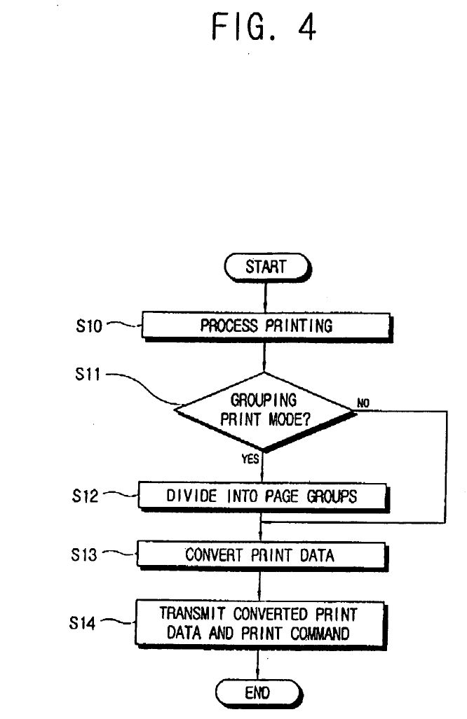

In a first example of the image forming apparatus 1, the printer driver 21 divides the print data into the page groups, converts the print data so that the print data belonging to each page group is printed in page number order in turn for each page group prior to a subsequent page being printed for a page group. Here, a converting process by which the printer driver 21 converts the print data will be described below with reference to FIG. 4.

First, when the print data supplied from the print data supplying unit 61 is in a printing process at operation S10. The control unit 20 determines whether the grouping print mode has been selected (operation S11). The printer driver 21 divides the print data into the plurality of page groups in page number order at operation S12.

The dividing process by which the printer driver 21 divides the print data into the exemplary two page groups is as follows.

The printer driver 21 detects the total number of pages of print data supplied from the print data supplying unit 61. Then, the printer driver 21 divides the detected total number of pages by the number of page groups to be classified. Because the number of the page groups is equal to the number of output trays, in this example, output trays 41 and 42, respectively. Therefore, the number of the page groups is two.

Accordingly, in the case that the print driver 21 receives the print data of ten pages from the print data supplying unit 61, the printer driver 21 obtains five by dividing the total page number of the print data by the number of the page groups.

At this moment, the printer driver 21 classifies the print data corresponding to pages one to five as the page group that will be output to the first output tray 41 (hereinafter, referred to as ‘a first page group’). Also, the printer driver 21 classifies the print data corresponding to pages six to ten as the page group that will be outputted to the second output tray 42 (hereinafter, referred to as ‘a second page group’). Here, a first printed page number in the second page group can be obtained based on ‘five’, the value obtained by dividing the number of the total pages of the print data by the number of the page groups.

The printer driver 21 converts the format of the print data into a format that can be processed by the printer control unit 22 at operation 13 based on the print data classified into the first page group and the second page group through the above process, so that the print data belonging to the first page group and the second page group is printed by the page and in turn for each group. Namely, the printer driver 21 converts the print data so that the image forming unit 10 prints the print data in the order, pages 1, 6, 2, 7, 3, 8, 4, 9, 5, and 10. The first page group, which is assigned to output tray 41, consists of pages 1 through 5. While the second page group, which is assigned to output tray 42, consists of pages 6 through 10. As can be seen in this example, with two output trays, 41 and 42, respectively, every other page goes to the tray designated to receive a particular page group.

Here, the page order of the print data printed by the image forming unit 10 is not limited to the above order, and any other page order can be employed provided that a user can arrange the papers 3 in page number order after the completion of the printing operation by merely putting together the papers 3 output to the first output tray 41 and the second output tray 42. For example, in the case that the image forming apparatus 1 outputs the printed paper 3 with its opposite side to a printed side facing the output trays 41 and 42, the printer driver 21 converts the print data so that the print data is printed by the image forming unit 10 in the order, pages 5, 10, 4, 9, 3, 8, 2, 7, 1, and 6. Also, in the case that the printed side of the paper 3 that is output to the first output tray 41 faces the bottom of the first output tray 41 and also that the side opposite to the printed side of the paper 3 that is output to the second output tray 42 also faces the top of the second output tray 42, the control unit 20 controls the image forming unit 10 so that the print data belonging to the page group corresponding to the first output tray 41 is printed in the correct page number order and the print data belonging to the page group corresponding to the second output tray 42 is printed in reverse page number order.

The printer driver 21 preferably converts the print data into the printer language like the printer common language (PCL), the post script (PS), or the like at operation S13.

Subsequently, the printer driver 21 transmits the converted print data to the printer control unit 22 through a host interface unit 62 at operation S14. At this moment, the printer driver 21 may transmit a print command, by which the papers 3 printed by the image forming unit 10 are transported to the first output tray 41 and the second output tray 42 in turn, to the printer control unit 22 by means of the printer language.

Here, the host interface unit 62 provided in the host 5 and a printer interface unit 50 provided in the image forming apparatus 1 can communicate with each other through a number of communicating systems. For example, the host interface unit 62 and the printer interface unit 50 can communicate with each other through a network, such as a parallel Centronics interface, USB interface, LAN (local area network), wireless, or the like.

The printer control unit 22 controls a printing operation of the image forming unit 10 based on the print data and/or the print command received through the printer interface unit 50. Here, the printer control unit 22 may convert the form of the print data converted by the printer driver 21 into a form to be processed by the image forming unit 10, for example, a bitmap form.

Here, the print data is printed and output in the order, the pages 1, 6, 2, 7, 3, 8, 4, 9, 5, and 10, based on the previous examples, by the image forming unit 10 according to control signals from the printer control unit 22.

Also, the printer control unit 22 controls the tray selecting unit 30 based on the print command received through the printer interface unit 50, so that the printed papers 3 through the image forming unit 10 are output to the first output tray 41 and the second output tray 42 in turn.

Accordingly, the five papers 3 on which the print data of the pages 1, 2, 3, 4, and 5 is printed are output to the first output tray 41 in page number order, and the five papers 3 on which the print data of the pages 6, 7, 8, 9, and 10 is printed are output to the second output tray 42 in page number order. Thus, the user can arrange the papers 3 in page number order by merely putting together the page groups of papers 3 output to the first output tray 41 and the second output tray 42.

In a second example of the image forming apparatus 1, the printer control unit 22 divides the print data into the page groups, and controls the image forming unit 10 so that the print data belonging to each page group is printed by the page and in turn for each group.

First, the printer driver 21 of the image forming apparatus 1 converts the print data provided from the print data supplying unit 61 into a form that can be processed by the printer control unit 22 by means of a compatible printer language. Next, the printer driver 21 provides the printer control unit 22 with the converted print data through the host interface unit 62.

The printer control unit 22 receives the converted print data through the printer interface unit 50, and stores the converted print data in a memory like RAM (random access memory) (not shown). Then, the printer control unit 22 divides the converted print data which is stored in the RAM into the first and second page groups in page number order. Here, a dividing process by which the printer control unit 22 divides the print data stored in the memory into the first and second page groups is the same as that by which the printer driver 21 divides the print data in the first example.

Also, the printer control unit 22 controls the image forming unit 10 so that the converted print data belonging to each page group is printed by the page and in turn for each group. Here, the printer control unit 22 controls the tray selecting unit 30 so that the papers 3 printed by the image forming unit 10 are output to the first output tray 41 and the second output tray 42 in turn. Accordingly, the image forming apparatus 1 according to the second example provides the same result as the image forming apparatus 1 according to the first example.

Returning to FIG. 1, the image forming apparatus 1 may further comprise a mode setting unit 70, which sets the device mode to output by page groups. Accordingly, the user can select whether to output by page groups through the mode setting unit 70, and the control unit 20 performs the grouping output according to the user's setting at operation S11 of FIG. 4.

In this embodiment, the mode setting unit 70 of the image forming apparatus 1 according to the first example may comprise a graphic user interface (not shown) provided by the printer driver 21, and an input device for the user to select whether to output by groups through the graphic user interface. Accordingly, the user can choose the mode from a choice bar provided by the printer driver 21 and disposed in the graphic user interface by the input device connected with the host 5, for example, a keyboard or a mouse, thereby setting the mode to output by page groups.

The mode setting unit 70 of the image forming apparatus 1 according to the second example may be provided on the exterior of the image forming apparatus 1 preferably in a form of a button, and the user can set the mode to output by groups through the button.

Further, in the same manner of the first example, the mode setting unit 70 of the image forming apparatus 1 according to the second example may comprise the graphic user interface provided by the printer driver 21, and the input device for selecting the mode to output by page groups through the graphic user interface. In the case that the user selects the page grouping output, the printer driver 21 transmits the user's selecting to the printer control unit 22 through the host interface unit 62, whereby the printer control unit 22 performs the page grouping print job.

In addition, when the control unit 20 of the image forming apparatus 1 detects that the print data is printed repeatedly in predetermined times, the control unit 20 may classify the page groups according to how many times the print data is printed repeatedly. For example, if the user sets the print data of ten pages to be printed twice, the control unit 20 classifies the print data corresponding to a first print job and a second print job into the first page group and the second page group, respectively. Therefore, the printed papers 3 output to the first output tray 41 are arranged from page one to page ten sequentially, and the printed papers 3 output to the second output tray 42 are arranged from one page to ten page sequentially.

As described above, in the image forming apparatus 1 are provided the image forming unit 10 for printing the image on the paper 3, the tray selecting unit 30 for outputting the printed paper 3 to one of a plurality of output trays 41 and 42, and the control unit 20 for dividing the print data into at least two or more page groups in page number order. The control unit 20, controls the image forming unit 10 so that the print data belonging to each page group is printed by the page and in turn, and controls the tray selecting unit 30 so that the printed paper 3 is transported to the output trays 41 and 42, the number of which is equal to or greater than the number of page groups, in turn. With this configuration, in the case that the print data of a plurality of pages is printed on the papers 3, the time interval between the papers 3 being output to the first output tray 41 and the second output tray 42 becomes longer, whereby blurring or smudging caused by contact with the toner or the ink of the papers 3 output to each output tray 41 and 42, respectively, is reduced.

Further, the image forming apparatus 1 does not print the print data sequentially in page number order, but divides the print data into the plurality of page groups according to page number order and then prints each page group in turn. Thus, the user can arrange the printed papers 3 in page number order by merely putting together the papers 3 output to the output trays 41 and 42, respectively.

Although exemplary embodiments of the present invention have been shown and described, it will be appreciated by those skilled in the art that changes or modifications may be made in these embodiments without departing from the principles and spirit of the invention, the scope of which is defined in the appended claims and their equivalents.

What is claimed is:

1. An image forming apparatus provided with a plurality of output trays, the image forming apparatus comprising:
an image forming unit for printing an image on a sheet of paper;
a tray selecting unit for outputting the printed paper to one of the plurality of output trays; and
a control unit for dividing print data into at least two or more page groups in page number order, wherein the control unit controls the image forming unit so that the print data belonging to each page group is printed one page at a time and for each page group in turn, and controls the tray selecting unit so that the printed paper is transported to the output trays in turn, wherein the number of output trays is equal to or greater than the number of page groups.

2. The image forming apparatus of claim 1, wherein the control unit comprises a printer control unit for controlling a printing operation of the image forming unit and a printer driver for converting a format of the print data into a format to be processed by the printer control unit; and
the printer driver divides the print data into the page groups and converts the format of the print data into the format to be processed by the printer control unit, so that the print data belonging to each page group is printed by the page and in turn for each group.

3. The image forming apparatus of claim 2, wherein the printer driver transmits a print command, by which the papers printed by the image forming unit are transported to each output tray in turn, to the printer control unit; and
the printer control unit controls the tray selecting unit if the print control unit receives the print command from the printer driver, so that the printed paper is output to the output trays in turn.

4. The image forming apparatus of claim 1, wherein the control unit comprises a printer control unit for controlling a printing operation of the image forming unit and a printer driver converting a format of the print data into the format to be processed by the printer control unit; and
wherein the printer control unit divides the converted print data provided from the printer driver into the page groups, and controls the image forming unit so that the converted print data belonging to each page group is printed by the page and for each group in turn.

5. The image forming apparatus of claim 1, wherein the control unit classifies the page groups according to how many times the print data is printed repeatedly when the control unit detects that the print data is printed repeatedly at predetermined times.

6. The image forming apparatus of claim 1, wherein the control unit divides the print data into the page groups, the number of which is equal to or less than the number of output trays.

7. The image forming apparatus of claim 1, further comprising a mode setting unit to set the mode to output by page groups;
wherein, in the case that the page grouping output is selected by the mode setting unit, the control unit controls the image forming unit so that the print data belonging to each page group is printed by the page and in turn for each group, and controls the tray selecting unit so that the printed papers are output to each output tray in turn.

8. The image forming apparatus of claim 1, wherein the output trays comprise a first output tray facing a printed side of the printed paper and a second output tray facing an opposite side of the printed side of the printed paper;
wherein the control unit controls the image forming unit, so that the print data belonging to the page group corresponding to the first output tray is printed by the image forming unit in page number order and the print data belonging to the page group corresponding to the second output tray is printed by the image forming unit in reverse page number order.

9. A control method of an image forming apparatus provided with a plurality of output trays, the control method comprising the steps of:
dividing print data into at least two or more page groups in page number order, wherein the page groups are assigned to a corresponding one of the plurality of output trays;
converting the print data so that the print data belonging to each page group is arranged by the page and in turn for each page group;
printing the converted print data on a sheet of paper; and
transporting the printed papers from a page group to the output tray assigned to the page group in turn, wherein the number of output trays equal to or greater than the number of page groups.

10. The control method of claim 9, wherein the step of dividing the print data into the at least two page groups comprises the steps of:
detecting the total page number of the print data; and
generating a first printed page number of each page group based on the detected total page number and the number of the page groups.

11. The control method of claim 10, wherein the step of dividing the print data into at least two or more page groups further comprises the steps of:
detecting whether the print data is repeatedly printed in predetermined times; and
dividing the page groups according to how many times the print data is printed repeatedly when detecting that the print data is printed repeatedly in the predetermined times.

12. The control method of claim 10, wherein the step of converting the print data comprises the step of converting the print data so that the print data is printed from the print data corresponding to a first printed page of each page group by the page and in turn for each page group.

13. The control method of claim 9, wherein the output trays comprise a first output tray facing a printed side of the printed paper and a second output tray facing the opposite side of the printed side of the printed paper;
wherein the step of converting the print data comprises the step of converting the print data, so that the print data belonging to the page group corresponding to the first output tray is printed in page number order and the print data belonging to the page group corresponding to the second output tray is printed in reverse page number order.
